(19) United States
(12) Patent Application Publication
(10) Pub. No.: US 2018/0181821 A1
(43) Pub. Date: Jun. 28, 2018

(54) RECOGNITION DEVICE

(71) Applicant: DENSO CORPORATION, Kariya-city (JP)

(72) Inventors: Shuichi SHIMIZU, Kariya-city (JP); Kenji OKANO, Kariya-city (JP); Takamichi TORIKURA, Kariya-city (JP)

(21) Appl. No.: 15/855,880

(22) Filed: Dec. 27, 2017

(30) Foreign Application Priority Data
Dec. 27, 2016 (JP) 2016-253505

(51) Int. Cl. G06K 9/00

(52) U.S. Cl. CPC G06K 9/00798; B60R 11/04

(57) ABSTRACT

The image processing device counts the number of lane marking feature points. The image processing device determines whether the count number of the lane marking feature points is equal to or greater than a first threshold. The image processing device arranges the setting to use the lane marking feature points in the lane marking detection process when the count number of the lane marking feature points is equal to or greater than the first threshold. On the other hand, the image processing device counts the number of Botts' Dot feature points when the count number of the lane marking feature points is smaller than the first threshold. The image processing device arranges the setting to use the Botts' Dot feature points in the lane marking detection process when the count number of the Botts' Dot feature points is equal to or greater than the second threshold.

### CROSS-REFERENCE TO RELATED APPLICATION

This application is based on and claims the benefit of priority from earlier Japanese Patent Application No. 2016-253505 filed Dec. 27, 2016, the description of which is incorporated herein by reference.

### BACKGROUND

### 1. Technical Field

The present disclosure relates to a technique for recognizing lane markings.

### 2. Related Art

Lane markings indicated on roads include dashed lane markings, besides solid lane markings having linear parts extending along the traveling direction of vehicles. Dashed lane markings include, for example, Botts' Dots and Cat's Eyes which form dotted lines in the traveling direction of vehicles. Botts' Dots are mainly used in North America, which are ceramic disks with a diameter of about 10 cm embedded in the road at certain intervals. Similarly to Botts' Dots, Cat's Eyes are embedded in the road at certain intervals, and have reflectors that reflect incident light in the same direction.

JP 2007-72512 A discloses a technique for selecting a detection mode according to the type of the lane marking and detecting the lane marking in the selected detection mode. Specifically, the boundary lines between a road and a lane marking in the captured image obtained from an imaging device mounted on the vehicle are extracted as feature points from the differences in their pixel values. The technique disclosed in JP 2007-72512 A selects the detection mode based on the number of extracted feature points. That is, when the number of feature points is equal to or larger than a threshold, the detection mode is set to a solid line mode. In other words, the detection mode is set to a mode for solid lane markings. On the other hand, when the number of feature points is smaller than the threshold, the detection mode is set to a dashed line mode. In other words, the detection mode is set to a mode for dashed lane markings. Thus, when the mode is set to the solid line mode, the technique disclosed in JP 2007-72512 A detects lane markings by a method suitable for detecting solid lines. When the mode is set to the dashed line mode, the lane markings are detected by a method suitable for detecting dashed lane markings.

On actual roads, there may be lane markings with few feature points, for example, faint solid lane markings whose paint has peeled off. According to the technique disclosed in JP 2007-72512 A, such lane markings with few feature points are determined to have feature points fewer than the threshold. Therefore, according to the technique disclosed in JP 2007-72512 A, the detection mode may be set to a mode for dashed lane markings. Thus, a lane marking with a small number of feature points will be erroneously determined as a dashed lane marking although it is not a dashed lane marking.

### SUMMARY

The present disclosure provides a technique that can appropriately recognize dashed lane markings.

An aspect of the technique of the present disclosure is a recognition device mounted on a vehicle. The recognition device includes an acquisition unit, a first detection unit, a second detection unit, and a recognition unit. The acquisition unit is configured to acquire a captured image from an imaging device mounted on the vehicle. The first detection unit is configured to detect a first feature point which is a feature point of a solid lane marking by carrying out a first detection process on the captured image. The second detection unit is configured to detect a second feature point which is a feature point of a dashed lane marking by carrying out a second detection process that is different from the first detection process on the captured image. The recognition unit is configured to recognize the solid lane marking or the dashed lane marking in the captured image. Further, the recognition unit is configured to recognize the solid lane marking based on the first feature point when the first feature point satisfies a first condition. The recognition unit is configured to recognize the dashed lane marking based on the second feature point when the first feature point does not satisfy the first condition and the second feature point satisfies a second condition.

According to the recognition device of the present disclosure, when the road has a lane marking having few feature points, for example, a worn lane marking or the like, the lane marking is determined not to satisfy the first condition nor the second condition. As a result, such a lane marking is excluded from the recognition targets of dashed lane markings. Therefore, the accuracy of recognition of dashed lane markings increases. Thus, according to the identification device of the present disclosure, it is possible to appropriately recognize dashed lane markings.

It is to be noted that the reference numbers in parentheses described in the aforementioned item column and in the claims indicate the correspondence with the specific means described in the embodiment described below as one aspect of the technique of the present disclosure. Thus, these reference numbers do not limit the technical scope of the present disclosure.

### BRIEF DESCRIPTION OF THE DRAWINGS

In the accompanying drawings:

FIG. 1 is a block diagram showing the configuration of an image processing device;

FIG. 2 is a flowchart showing image processing;

FIG. 3 is a flowchart showing the procedure for detecting a lane marking;

FIG. 4 is a schematic view showing feature points of a lane marking (part 1);

FIG. 5 is a schematic view showing feature points of a lane marking (part 2);

FIG. 6 is a schematic view showing feature points of a Botts' Dot (part 1);

FIG. 7 is a schematic view showing feature points of a Botts' Dot (part 2);

FIG. 8 is a diagram showing an example of the case where feature points of a worn line are used;

FIG. 9 is a diagram showing that the circumscribed quadrangle is similar to the shape of the preset quadrangle (part 1);

FIG. 10 is a diagram showing that the circumscribed quadrangle is similar to the shape of the preset quadrangle (part 2);

FIG. 11 is a diagram showing that the circumscribed quadrangle is not similar to the shape of the preset quadrangle (part 1);

FIG. 12 is a diagram showing that the circumscribed quadrangle is not similar to the shape of the preset quadrangle (part 2);

FIG. 13 is a diagram showing that the circumscribed quadrangle is not similar to the shape of the preset quadrangle (part 3); and

FIG. 14 is a diagram showing an edge search executed in an edge search region.

### DETAILED DESCRIPTION OF THE PREFERRED EMBODIMENTS

An embodiment for implementing the technique of the present disclosure will be described with reference to the drawings.

### 1. Configuration of Image Processing Device 1

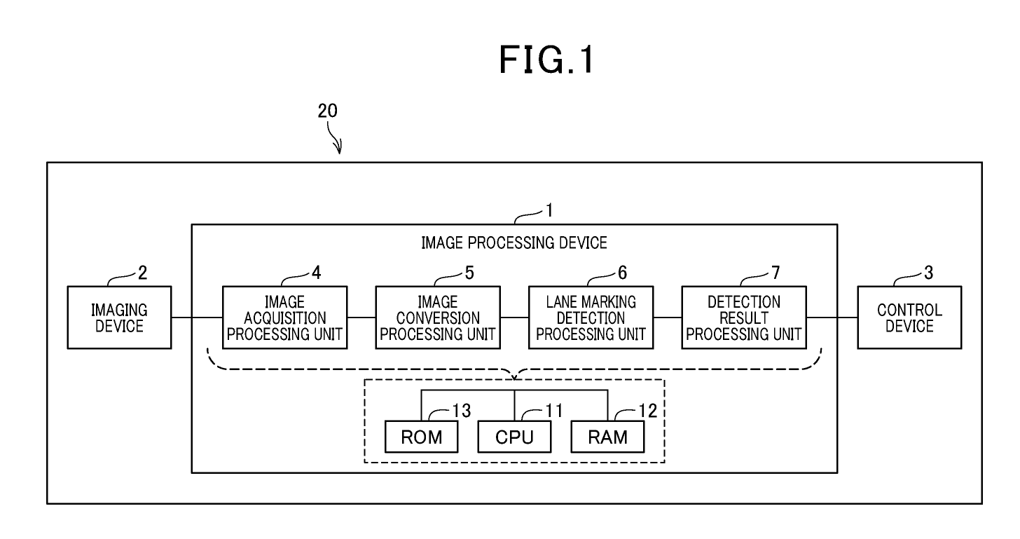

The configuration of an image processing device 1 according to the present embodiment will be described with reference to FIG. 1. The image processing device 1 is mounted on a vehicle and is a device that recognizes lane markings. In the following description, the vehicle on which the image processing device 1 is mounted is referred to as an own vehicle 20. The image processing device 1 is connected with an imaging device 2 and a control device 3.

The imaging device 2 includes, for example, four cameras for capturing respective images of the front, the left side, the right side, and the rear. The imaging device 2 is installed at predetermined positions of the own vehicle 20. Specifically, the front camera is installed such that the road surface ahead the own vehicle 20 can be an imaging area. The left-side camera is installed such that the road surface on the left of the own vehicle 20 can be an imaging area. The right-side camera is installed such that the road surface on the right of the own vehicle 20 can be an imaging area. The rear side camera is installed such that the road surface behind the own vehicle 20 can be an imaging area. Each camera repeatedly captures an image of the imaging area at predetermined intervals (for example, at 1/15 second intervals). Then, the imaging device 2 outputs the captured images to the image processing device 1.

Based on the recognition result of the lane marking output from the image processing device 1, the control device 3 controls the steering, braking, engine, etc. of the own vehicle 20 so that the own vehicle 20 travels within the lane.

The image processing device 1 is, for example, an ECU (Electronic Control Unit). The image processing device 1 comprises a microcomputer including a semiconductor memory such as a CPU 11, a RAM 12, a ROM 13, and a flash memory. The image processing device 1 is configured such that the CPU 11 executes the programs stored in a non-transitional substantive storage medium. The image processing device 1 thereby realizes each of the functions described later. In the present embodiment, the semiconductor memory corresponds to the non-transitory computer-readable storage medium for storing programs. Further, in the image processing device 1, a processing procedure (method) defined in a program is executed by execution of the program. The number of microcomputers constituting the image processing device 1 is not limited to one. It may be two or more.

The image processing device 1 includes an image acquisition processing unit 4, an image conversion processing unit 5, a lane marking detection processing unit 6, and a detection result processing unit 7. The way of realizing these functions (constituent elements) is not limited to methods using software such as the program described above. As another method, for example, the elements of a part or all the functions may be realized by using hardware combining logic circuits, analog circuits, and the like. The image acquisition processing unit 4 acquires a captured image from the imaging device 5. The image conversion processing unit 5 performs predetermined image processing on the acquired captured image and converts the image. The lane marking detection processing unit 6 detects a lane marking from the converted image. The detection result processing unit 7 outputs the detection result of the lane marking to the control device 3.

### 2. Image Processing

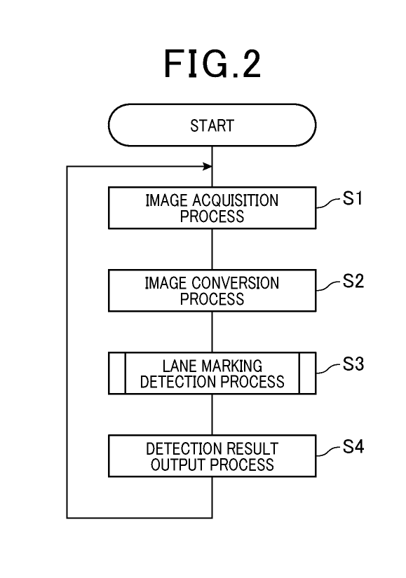

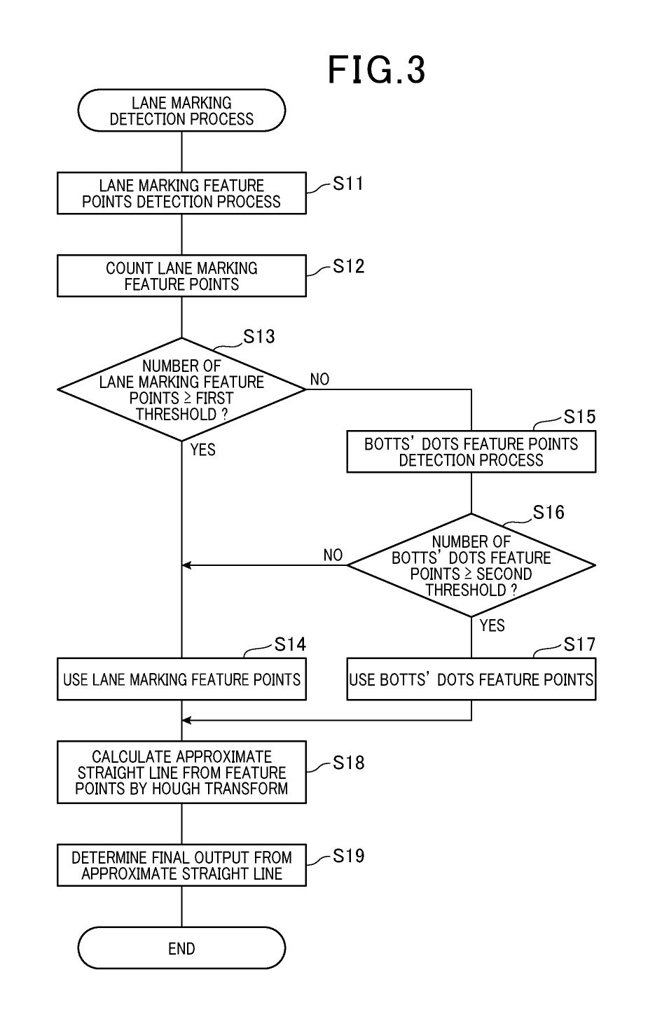

The image processing executed by the image processing device 1 will be described with reference to the flowcharts of FIGS. 2 and 3. This processing is executed at predetermined time intervals such as 1/15 seconds while the ignition switch of the own vehicle 20 is ON.

As shown in FIG. 2, the image processing device 1 performs a process of acquiring captured images from the front camera, the left-side camera, the right-side camera, and the rear camera (step S1).

Next, the image processing device 1 performs predetermined image processing on the four captured images acquired by the process of step S1 and converts the images (step S2). Specifically, the image processing device 1 converts the four captured images into bird's-eye view images viewed from a preset virtual viewpoint and synthesizes them. That is, the image processing device 1 performs a bird's-eye conversion on the four captured images. As a result, the image processing device 1 generates a bird's-eye view image showing the surroundings of the own vehicle 20. In other words, the image processing device 1 converts and synthesizes the captured images into a bird's-eye view image, which is an image of a viewpoint looking down from above the own vehicle 20 by performing a bird's-eye view conversion.

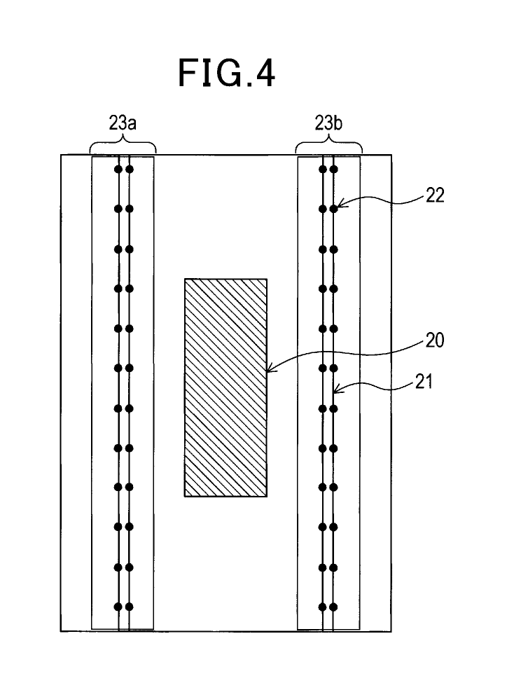

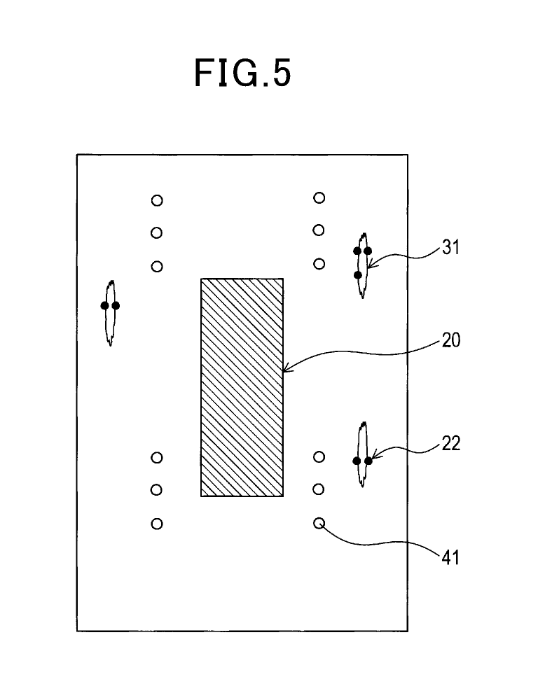

Next, the image processing device 1 performs a process for detecting a lane marking from the bird's-eye view image generated by the process of step S2 (step S3). That is, the image processing device 1 executes a lane marking detection process. A lane marking here indicates a line drawn on the road surface so as to define a lane on the road. Examples of the lane marking include a solid line 21 as shown in FIG. 4, a dashed line, and a worn line 31 as shown in FIG. 5. In the following description, lines drawn on the road surface including lines that are not white are collectively referred to as lane markings. Details on the lane marking detection process will be described later.

Next, the image processing device 1 performs a process for outputting the detection result of the lane marking by the process of step S3 to the control device 3 (step S4). Then, when the ignition switch is turned off, the image processing device 1 ends the image processing.

In present embodiment, the process in step S1 corresponds to a process executed by the image acquisition processing unit 4. The process in step S2 corresponds to a process executed by the image conversion processing unit 5. The process in step S3 corresponds to a process executed by the lane marking detection processing unit 6. The process in step S4 corresponds to a process executed by the detection result processing unit 7.

Next, the specific processing procedure of the lane marking detection processing will be described using the flowchart of FIG. 3. This processing is executed by the lane marking detection processing unit 6 of the image processing device 1. This processing divides the bird's-eye view image into left and right parts approximately equally, and is performed on each of the divided left region and the right region.

The lane marking detection processing unit 6 performs a process for detecting of lane marking feature points 22 (step S11). FIG. 4 is a schematic diagram showing an example of the lane marking feature points 22. The lane marking feature points 22 may be, for example, edge points. The edge points are points where the luminance change is large when scanning the bird's eye view in the direction perpendicular to the traveling direction of the own vehicle along the road. The lane marking detection processing unit 6 extracts edge points from the bird's-eye view image based on this feature. As a result, the lane marking feature points 22 are detected based on the arrangement state of the extracted edge points, etc. In the second and subsequent cycles, the lane marking detection processing unit 6 may perform the process of step S11 in only partial regions 23a and 23b including the previously detected lane marking feature points 22. In addition, the lane marking detection processing unit 6 detects the lane marking feature points 22 of a lane marking like the worn line 31 shown in FIG. 5 in the same way.

Next, the lane marking detection processing unit 6 counts the number of the lane marking feature points 22 detected by the process of step S11 (step S12).

Then, the lane marking detection processing unit 6 performs a process of determining whether the number of the lane marking feature points 22 counted by the process of step S12 is equal to or greater than a first threshold (step S13). The first threshold is a criterion (determination reference) for determining whether to use the counted lane marking feature points 22 in the lane marking detection process. When the result of the determination in the process of step S13 is positive (YES at step S13), the lane marking detection processing unit 6 proceeds to step S14. The lane marking detection processing unit 6 then arranges the setting to use the counted lane marking feature points 22 in the process of step S18 (step S14). For example, as in the example shown in FIG. 4, when a lane marking of the solid line 21 exists in the image, the lane marking detection processing unit 6 determines that the count number of the lane marking feature points 22 is equal to or larger than the first threshold. As a result, the lane marking detection processing unit 6 arranges the setting to use the lane marking feature points 22 of the solid line 21 in the process of the subsequent step S18.

On the other hand, when the result of the determination in the process of step S13 is negative (NO at step S13), the lane marking detection processing unit 6 proceeds to step S15. For example, as in the example shown in FIG. 5, when a lane marking of a worn line 31 exists in the image, the lane marking detection processing unit 6 determines that the count number of the lane marking feature points 22 is smaller than the first threshold.

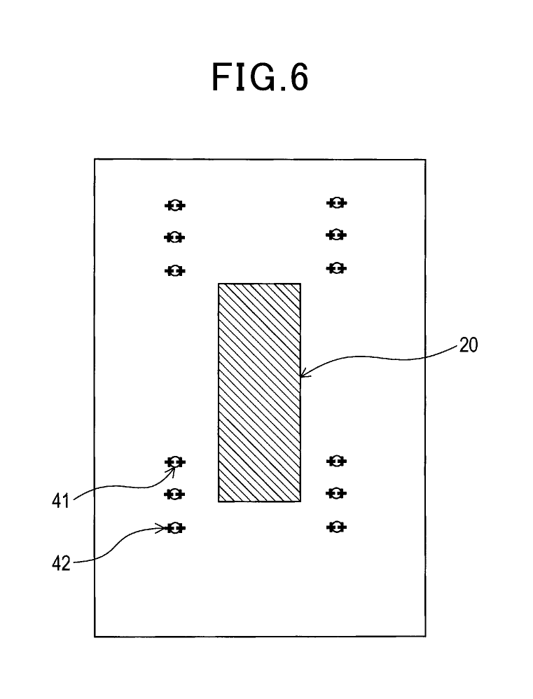

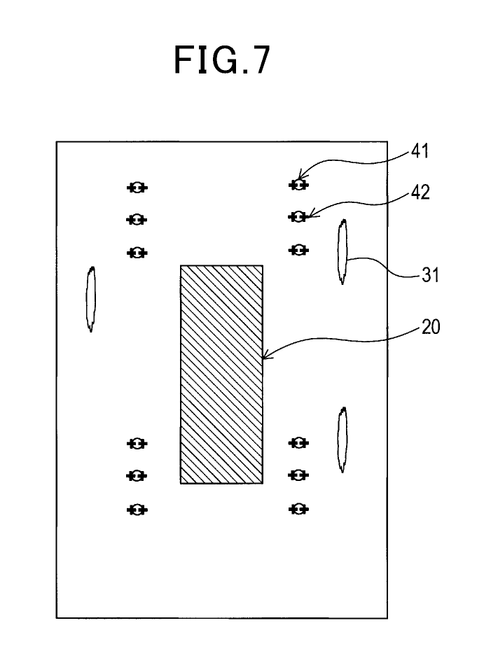

The lane marking detection processing unit 6 performs a process for detecting the feature points 42 of Botts' Dots 41 and counting the number of the detected feature points 42 of the Botts' Dots 41 (step S15). FIGS. 6 and 7 are schematic diagrams showing an example of the feature points 42 of the Botts' Dots 41. FIG. 7 shows the bird's-eye view image of FIG. 5 after detecting the features point 42 of the Botts' Dots 41.

The specific process of step S15 executed by the lane marking detection processing unit 6 will be described with reference to FIGS. 9 to 14. First, the lane marking detection processing unit 6 performs a filtering process on the bird's-eye view image converted by the image conversion processing unit 5. The lane marking detection processing unit 6 thereby emphasizes the circular shapes of about 10 cm as the Botts' Dots 41 in the captured image of a predetermined area of the road surface.

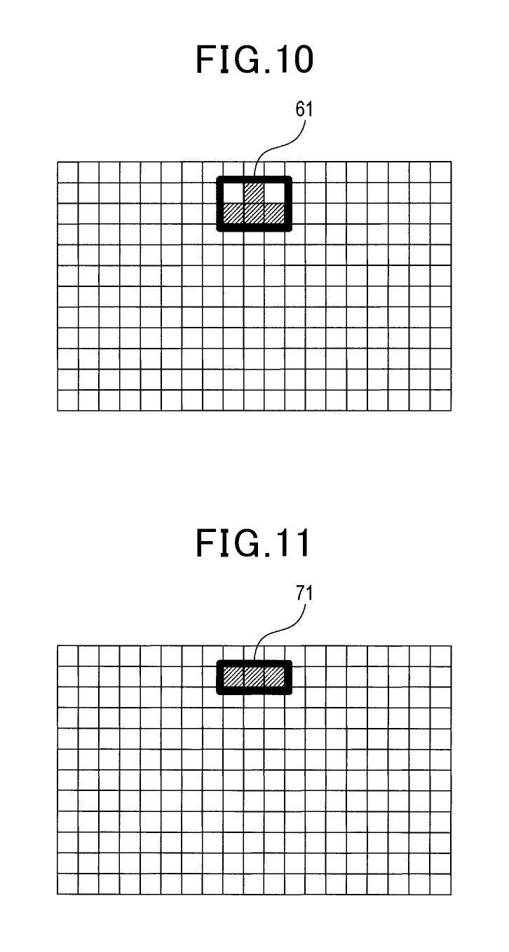

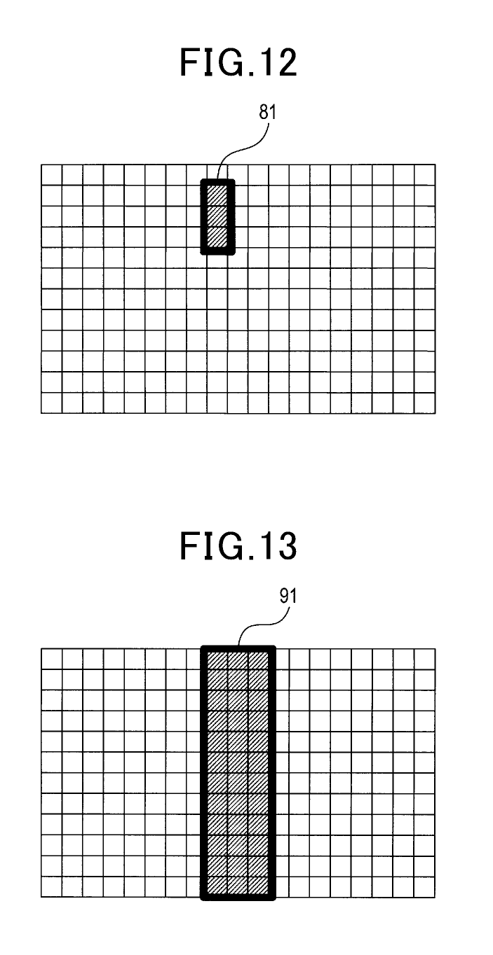

Next, the lane marking detection processing unit 6 performs a labeling process in which a cluster of pixels having similar pixel values are processed as one group in the image. Thus, the lane marking detection processing unit 6 extracts a circumscribed quadrangular region corresponding to the pixel cluster from the image. Then, the lane marking detection processing unit 6 determines whether or not the region shape of the circumscribed quadrangle extracted by the labeling processing is similar to the shape of a preset quadrangle. As a result, when the region shape of the circumscribed quadrangle is similar to the predetermined quadrangular shape, the lane marking detection processing unit 6 identifies the circumscribed quadrangle as an edge search region. An edge search region is an object image region (a partial region including a dashed lane marking) in which the feature points 42 of the Botts' Dots 41 are detected. Further, the preset quadrangle is a circumscribed quadrangle of a circular shape representing the shape of the Botts' Dots 41, and has predetermined ranges of width and length. The process of identifying an edge search region of the Botts' Dots 41 will be described in detail with reference to FIGS. 9 to 13. In the following description, as shown in FIGS. 9 to 13, a case where a square with a side length of 2 cm to 4 cm forms a single cell will be described as an example. For example, a circumscribed quadrangle 51 shown in FIG. 9 is 3 cells×3 cells. A circumscribed quadrangle 61 shown in FIG. 10 is 2 cells×3 cells. Such circumscribed quadrangles 51, 61 have widths and lengths within the predetermined range. Therefore, it is determined that the circumscribed quadrangles 51, 61 are similar to the shape of the preset quadrangle. The regions of the circumscribed quadrangles 51, 61 are specified as edge search regions for the Botts' Dots 41. On the other hand, for example, circumscribed quadrangles 71, 81 shown in FIGS. 11 and 12 are 1 cells×3 cells. At least one of the width and length of such circumscribed quadrangles 71, 81 is extremely small and they do not have a width and/or length within the predetermined range. Therefore, it is determined that the circumscribed quadrangles 71, 81 are not similar to the shape of the preset quadrangle. That is, the regions of the circumscribed quadrangles 71, 81 are specified not as edge search regions for the Botts' Dots 41 but as noises on the road surface (a partial region not including a dashed lane marking). Further, for example, a circumscribed quadrangle 91 shown in FIG. 13 is 12 cells×3 cells. At least one of the width and length of such circumscribed quadrangle 91 is extremely large and exceeds the predetermined range greatly. Therefore, it is determined that the circumscribed quadrangle 91 is not similar to the shape of the preset quadrangle.

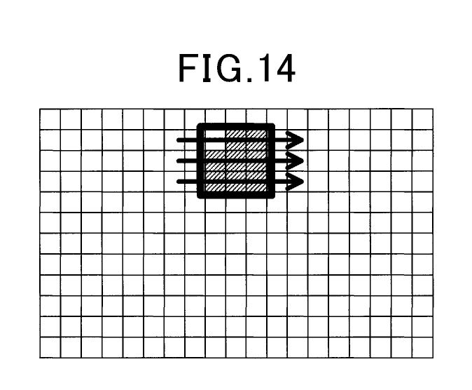

Next, the lane marking detection processing unit 6 executes edge search on the specified edge search region, and detects the feature points 42 of the Botts' Dots 41. Then, the lane marking detection processing unit 6 counts the number of the detected feature points 42 of the Botts' Dots 41. FIG. 14 shows an example of edge search executed on an edge search region. In the example shown in FIG. 14, the image is scanned in the horizontal direction, and eight feature points 42 of the Botts' Dots 41 are detected from the edge search region.

Returning to the explanation of FIG. 3, the lane marking detection processing unit 6 performs a process of determining whether the number of the feature points 42 of the Botts' Dots 41 counted by the process of step S15 is equal to or greater than a second threshold (step S16). The second threshold is a criterion (determination reference) for determining whether to use the feature points 42 of the Botts' Dots 41 in the lane marking detection process.

When the result of the determination in the process of step S16 is positive (YES at step S16), the lane marking detection processing unit 6 proceeds to step S17. The lane marking detection processing unit 6 then arranges the setting to use the feature points 42 of the Botts' Dots 41 in the process of step S18 (step S17). For example, as in the example shown in FIG. 6, when consecutive Botts' Dots 41 exist along the lane in the image, the lane marking detection processing unit 6 determines that the count number of the feature points 42 of the Botts' Dots 41 is equal to or larger than the second threshold. As a result, the lane marking detection processing unit 6 arranges the setting to use the feature points 42 of the Botts' Dots 41 in the subsequent process of step S18.

Further, as in the example shown in FIG. 7, when the worn line 31 and consecutive Botts' Dots 41 exist in the image, the lane marking detection processing unit 6 determines that the count number of the feature points 42 of the Botts' Dots 41 is equal to or larger than the second threshold. As a result, the lane marking detection processing unit 6 arranges the setting to use the feature points 42 of the Botts' Dots 41 in the subsequent process of step S18. That is, the used feature points 42 of the Botts' Dots 41 do not include the feature points 22 of the worn line 31. In the present processing, the feature points 22 of the worn line 31 are excluded by the process of specifying the edge search region for the Botts' Dots 41.

Meanwhile, when the result of the determination in the process of step S16 is negative (NO at step S16), the lane marking detection processing unit 6 proceeds to the step S14. As a result, the lane marking detection processing unit 6 arranges the setting to use the lane marking feature points 22 detected by the process in step S11 in the process of step S18 (step S14). That is, when it is determined that the count number of the feature points 42 of the Botts' Dots 41 is smaller than the second threshold, the lane marking detection processing unit 6 does not use the feature points 42 of the Botts' Dots 41 in the process of step S18.

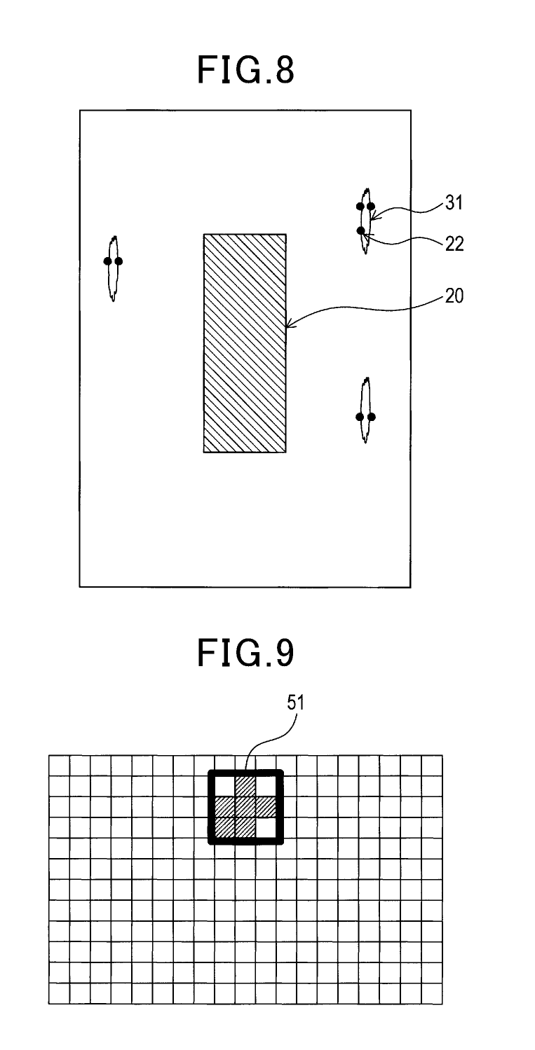

As in the example shown in FIG. 8, when the Botts' Dots 41 do not exist but a worn line 31 exists in the image, the lane marking detection processing unit 6 determines that the count number of the feature points 42 of the Botts' Dots 41 is smaller than the second threshold. As a result, the lane marking detection processing unit 6 arranges the setting to use the feature points 22 of the worn line 31 in the subsequent process of step S18.

Next, the lane marking detection processing unit 6 calculates an approximate straight line by the Hough transform using the feature points 22 or feature points 42 set in the corresponding process of preceding steps S14 or S17 (step S18). The Hough transform is a method of feature extraction used in digital image processing. The lane marking detection processing unit 6 of the image processing device 1 determines the final output from the approximate line obtained by the process of step S18 (step S19). That is, the lane marking detection processing unit 6 detects a lane marking from the bird's-eye view image. Then, based on the detection result, the lane marking detection processing unit 6 outputs information on the own vehicle 20 and the lane marking. Specifically, for example, the lane marking detection processing unit 6 determines the distance from the own vehicle 20 to a lane marking, the angle between the center of the own vehicle 20 and the lane marking, and the like, and ends the lane marking detection processing.

### 3. Effects

According to the present embodiment described above in detail, the following effects can be obtained.

(1) The image processing device 1 according to the present embodiment carries out a two-stage determination process in steps S13 and S16 by the lane marking detection processing unit 6. For example, when it is determined that the count number of the lane marking feature points 22 is equal to or larger than the first threshold in the first determination process (step S13) (when the first condition is satisfied), the counted lane marking feature points 22 are used in the lane marking detection process. On the other hand, when it is determined that the count number of the lane marking feature points 22 is smaller than the first threshold, the feature points 42 of the Botts' Dots 41 are used in the lane marking detection process. In this case, the feature points 22 of a worn line 31 may be erroneously used as the feature points 42 of the Botts' Dots 41. However, as described above, the image processing device 1 according to the present embodiment carries out a two-stage determination process. Specifically, when it is determined that the count number of the feature points 42 of the Botts' Dots 41 is equal to or larger than the second threshold in the second determination process (step S16) (when the second condition is satisfied), the feature points 42 of the Botts' Dots 41 are used in the lane marking detection process. Meanwhile, when it is determined that the count number of the feature points 42 of the Botts' Dots 41 is smaller than the second threshold in the second determination process (when the second condition is not satisfied), the feature points 42 of the Botts' Dots 41 are not used in the lane marking detection process. As a result, the image processing device 1 avoid including the feature points 22 of the worn line 31 having few feature points in the feature points 42 of the Botts' Dots 41 used in the process of step S18. That is, in the present embodiment, the feature points 22 of the worn line 31 are excluded from the lane marking detection target. Therefore, according to the image processing device 1 of the present embodiment, the accuracy of recognition of the feature points 42 of the Botts' Dots 41 increases. Thus, the image processing device 1 can appropriately recognize the Botts' Dots 41 (dashed lane markings).

(2) When a negative determination is made in step S16, the image processing device 1 according to the present embodiment uses the lane marking feature points 22 in the process of step S18. For example, the count number of the lane marking feature points 22 is smaller than the first threshold. The count number of the feature points 42 of the Botts' Dots 41 is smaller than the second threshold. In such a case, there may be no feature points 22, 42 available in the process of step 18 and thus, the final result may not be output. To cope with this, when a negative determination is made in step S16 as described above, the image processing device 1 according to the present embodiment uses the lane marking feature points 22 in the process of step S18. As a result, if the lane marking feature points 22 like a worn line 31 exist, the lane marking feature points 22 is used in the process of step S18. Thus, the image processing device 1 can output the final result.

(3) When the region shape of a circumscribed quadrangle in the image extracted by the labeling process is similar to the shape of a preset quadrangle, the image processing device 1 of the present embodiment specifies the circumscribed quadrangle as an edge search region. As a result, in the present embodiment, noises on the road surface (a partial region not including a dashed lane marking), and circumscribed quadrangles which greatly exceed the range of preset quadrangular shapes (for example, a solid line or a dashed line) are excluded. Therefore, according to the image processing device 1 of the present embodiment, the accuracy of recognition of the Botts' Dots 41 increases. Thus, the image processing device 1 can appropriately recognize the Botts' Dots 41.

In the present embodiment, the image processing device 1 corresponds to a recognition device. The process in step S1 executed by the image acquisition processing unit 4 corresponds to a process of an acquisition unit. The processes in steps S11 and S12 executed by the lane marking detection processing unit 6 correspond to a process of a first detection unit (first detection process). The lane marking correspond to a solid lane marking. The lane marking feature points 22 correspond to first feature points. The process in step S15 executed by the lane marking detection processing unit 6 corresponds to a process of a second detection unit (second detection process that is different from the first detection process). The Botts' Dots 41 correspond to a dashed lane marking. The feature points 42 of the Botts' Dots 41 correspond to second feature points. The processes in steps S14 and S17 executed by the lane marking detection processing unit 6 correspond to a process of the recognition unit. The number of lane marking feature points 22 being greater than or equal to the first threshold corresponds to the first condition. The number of the feature points 42 of the Botts' Dots 41 being greater than or equal to the second threshold corresponds to the second condition.

### 4. Other Embodiments

An embodiment for implementing the technique of the present disclosure has been described above, but the technique of the present disclosure is not limited to the above-described embodiment. For example, the technique of the present disclosure can be implemented with various modifications as described below.

(a) In the above-described embodiment, the Botts' Dots 41 were shown as an example of a dashed lane marking, but the present disclosure is not limited to this. The dashed lane marking may be, for example, chatter bars including Cat's Eyes.

(b) In the above-described embodiment, an example was shown in which the image processing device 1 performs the lane marking detection process on a bird's-eye view image, but the present disclosure is not limited to this. The lane marking detection process may be performed on the captured image, for example.

(c) In the above-described embodiment, an example was shown in which the image processing device 1 proceeds to the step S14 after a negative determination has been made in step S16, but the present disclosure is not limited to this. For example, the image processing device 1 may end the lane marking detection process after a negative determination has been made in the process of step S16.

(d) A plurality of functions possessed by a single element in the above embodiment may be realized by a plurality of elements. A single function possessed by a single element may be realized by a plurality of elements. A plurality of functions possessed by a plurality of elements may be realized by a single element. A single function realized by a plurality of elements may be realized by a single element. Further, a part of the configuration of the above embodiment may be omitted. Furthermore, at least a part of the configuration of the above embodiment may be added or substituted in the configuration of the other embodiments described above. The embodiments of the technique according to the present disclosure include various modes included in the technical scope determined by the language of the claims, without departing from the scope of the present disclosure.

(e) The technique of the present disclosure can be realized by various forms such as the following system, program, computer readable storage medium, method, etc., in addition to the image processing device 1 described above. Specifically, the system is a recognition system including the image processing device 1 as a component. The program is a recognition program for causing a computer to function as the image processing device 1. The storage medium is a non-transitory computer readable storage medium such as a semiconductor memory in which the recognition program is stored. The method is a recognition method for recognizing lane markings.

What is claimed is:

1. A recognition device mounted on a vehicle, comprising:
an acquisition unit configured to acquire a captured image from an imaging device mounted on the vehicle;
a first detection unit configured to detect a first feature point which is a feature point of a solid lane marking from the captured image;
a second detection unit configured to detect a second feature point which is a feature point of a dashed lane marking from the captured image; and
a recognition unit configured to recognize the solid lane marking or the dashed lane marking in the captured image, wherein
the recognition unit is configured to
recognize the solid lane marking based on the first feature point when the first feature point satisfies a first condition, and
recognize the dashed lane marking based on the second feature point when the first feature point does not satisfy the first condition and the second feature point satisfies a second condition.

2. The recognition device according to claim 1, wherein
the recognition unit is configured to
recognize the solid lane marking based on the number of the first feature points when the number of the first feature points satisfies the first condition, and
recognize the dashed lane marking based on the number of the second feature points when the number of the first feature points does not satisfy the first condition, and the number of the second feature points satisfies the second condition.

3. The recognition device according to claim 2, wherein
the first condition is that the number of the first feature points is equal to or greater than a first threshold, and
the second condition is that the number of the second feature points is equal to or greater than a second threshold.

4. The recognition device according to claim 1, wherein
the recognition unit is configured to recognize the solid lane marking based on the first feature point when the first feature point does not satisfy the first condition and the second feature point does not satisfy the second condition.

5. The recognition device according to claim 1, wherein
the second detection unit is configured to specify a partial region including the dashed lane marking in the captured image and detect the second feature point in the partial region.

6. The recognition device according to claim 5, wherein
the second detection unit is configured to extract a group of pixels having similar pixel values from the captured image, and to specify the group of pixels as the partial region when the region shape of the group of pixels is similar to the shape of the dashed lane marking.
